(19) United States
(12) Patent Application Publication
(10) Pub. No.: US 2011/0172913 A1
(43) Pub. Date: Jul. 14, 2011

(54) ROAD LEARNING APPARATUS

(75) Inventors: Shuuji NAKAMURA, Chita-gun (JP); Osamu Kanematsu, Nagoya-city (JP); Takeshi Shikimachi, Kariya-city (JP)

(73) Assignee: DENSO CORPORATION, Kariya-city (JP)

(21) Appl. No.: 12/911,293

(22) Filed: Oct. 25, 2010

(30) Foreign Application Priority Data
Jan. 14, 2010 (JP) 2010-5896

(51) Int. Cl. G01C 21/26; G01C 21/12

(52) U.S. Cl. 701/208

(57) ABSTRACT

In adding a new road to update road map data, an amendment process is executed to remove an accumulated error included in a travel locus based on dead reckoning navigation at the time of running the new road. The new road can be thus added in updating the road map data so as to fit more with an actual shape of the new road.

### CROSS REFERENCE TO RELATED APPLICATION

The present application is based on and incorporates herein by reference Japanese Patent Application No. 2010-5896 filed on Jan. 14, 2010.

### FIELD OF THE INVENTION

The present invention relates to a road learning apparatus which registers a new road in road map data using a travel locus generated when moving a road which is not stored in the road map data.

### BACKGROUND OF THE INVENTION

[Patent document 1] JP-H6-201392 A

There is known a technology when a vehicle travels a road, which is not stored in an existing road map data, such as a newly opened road, the existing road map data is updated by executing the reflection of the road on the road map data by automatically changing, amending, and adding. For example, in a technology described in Patent document 1, a travel locus of a vehicle is generated based on a dead reckoning navigation when the vehicle travels a new road; the generated travel locus is inserted in between a starting point and a terminating point in the road map data through rotating, expanding, or reducing the shape of the travel locus; the new road is thereby learned to thereby update the road map data.

The above technology however poses the following disadvantage. The travel locus using the dead reckoning navigation is calculated based on the travel distance and travel direction of the vehicle. The lineal shape of the travel locus therefore becomes a smooth locus. In contrast, there is an influence of the voltage offset generated from the gyro sensor for detecting the vehicle travel direction; thus, the error accumulates with the increase of the travel distance. Please refer to FIG. 7A, and FIG. 7B, where a new road 1022 is opened between (i) a connection point or starting point 1029 of a first existing road 1020 and (ii) a connecting point 1030 of a second existing road 1023. A travel locus 1028 of the vehicle becomes a lineal shape different from an actual shape of the new road 1022; as a result, a gap or error arises between (i) the connecting point 1030 at which the actual new road 1022 is connected with the second existing road 1023 and (ii) a returning point 1027 at which the obtained travel locus 1028 is connected with the second existing road 1023. In updating the road map data by such description in Patent document 1, the learning of the new road is executed without taking into consideration the error by the dead reckoning navigation such that the learned travel locus 1025 is inserted in between (I) the separating point 1029 from the first existing road 1020 and (ii) the connecting point 1030 to the second existing road 1023. As illustrated in FIG. 7B, the learned travel locus 1025 learned as a new road becomes much deviated or different from the actual lineal shape 1022 of the new road. This poses a disadvantage.

### SUMMARY OF THE INVENTION

The present invention is made in view of the above disadvantage. It is an object to provide a road learning apparatus which learns a new road so as to try to accord with an actual road shape of the new road in updating road map data by adding a travel locus based on a dead reckoning navigation.

To achieve the above object, according to an example of the present invention, a road learning apparatus for a vehicle is provided as follows. A road map storage device is configured to store road map data. A vehicle position detection device is configured to detect a position of the vehicle using a dead reckoning navigation. A travel locus storage device is configured to store a travel locus generated by a movement of a vehicle position detected by the vehicle position detection device. A new road travel determination section is configured to execute a new road travel determination as to whether the vehicle travels a new road that is not contained in the stored road map data. A new road update section is configured to update the road map data in the road map storage device by adding a new road based on a travel locus stored in the travel locus storage device when the new road travel determination is affirmatively made. An error accumulation calculation section is configured to calculate, when the new road travel determination is affirmatively made, an error which is accumulated in a first travel locus corresponding to the new road for a duration for which the vehicle travels the new road. An error accumulation amendment section is configured to amend the accumulated error calculated by the error accumulation calculation section with respect to the first travel locus to obtain a second travel locus as a post-amendment travel locus. Herein, the new road update section is further configured to update the road map data in the road map storage device by adding as the new road the post-amendment travel locus obtained by the error accumulation amendment section.

According to the above configuration, when updating the road map data by adding as a new road a travel locus, which is traveled by the vehicle and is corresponding to the new road, an error is calculated which is accumulated in the travel locus corresponding to the new road for a duration for which the vehicle travels the new road or the travel locus and the travel locus is amended based on the calculated error. This allows the addition of the new road in the road map data to meet the actual shape of the new road.

According to another example of the present invention, a method for updating road map data to add a new road is provided for a vehicle having a storage device storing the road map data, and a vehicle position detection device detecting a position of the vehicle using a dead reckoning navigation. The method comprises: recording a travel locus generated by a movement of a vehicle position detected by the vehicle position detection device; executing a new road travel determination as to whether the vehicle travels a new road that is not contained in the stored road map data; defining, when the new road travel determination is affirmatively made, within the recorded travel locus, a first travel locus corresponding to the new road for a duration for which the vehicle travels the new road; calculating an error which is accumulated in the first travel locus corresponding to the new road for the duration for which the vehicle travels the new road; amending the calculated error accumulated in the first travel locus to obtain a second travel locus as a post-amendment travel locus; and updating the road map data in the storage device by adding as the new road the obtained post-amendment travel locus.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating an overall configuration of a vehicular navigation apparatus according to an embodiment of the present invention;

FIGS. 2A to 2D are diagrams for explaining an error produced on a travel locus of a vehicle at the time of running a new road according to the present embodiment;

FIGS. 3A to 3E are diagrams for explaining an amendment process for an error produced on a new road feasibility travel locus according to the present embodiment;

FIGS. 4A to 4C are diagrams for explaining a road learning process according to the present embodiment;

FIG. 5 is a flowchart diagram for explaining a road learning process according to the present embodiment;

FIG. 6 is a flowchart illustrating a subroutine of an amendment process according to the present embodiment; and

FIGS. 7A to 7B are diagrams for explaining a road learning process using a travel locus based on the dead reckoning navigation in a prior art.

### DETAILED DESCRIPTION OF THE PREFERRED EMBODIMENTS

An embodiment of the present invention is explained with reference to drawings. It is noted that the present embodiment explains an example in which a road learning apparatus is applied to a vehicular navigation apparatus in a subject vehicle. In addition, the embodiment of the present invention can be modified in various manners within a technical scope of the present invention without being limited to the following embodiment.

### Embodiment

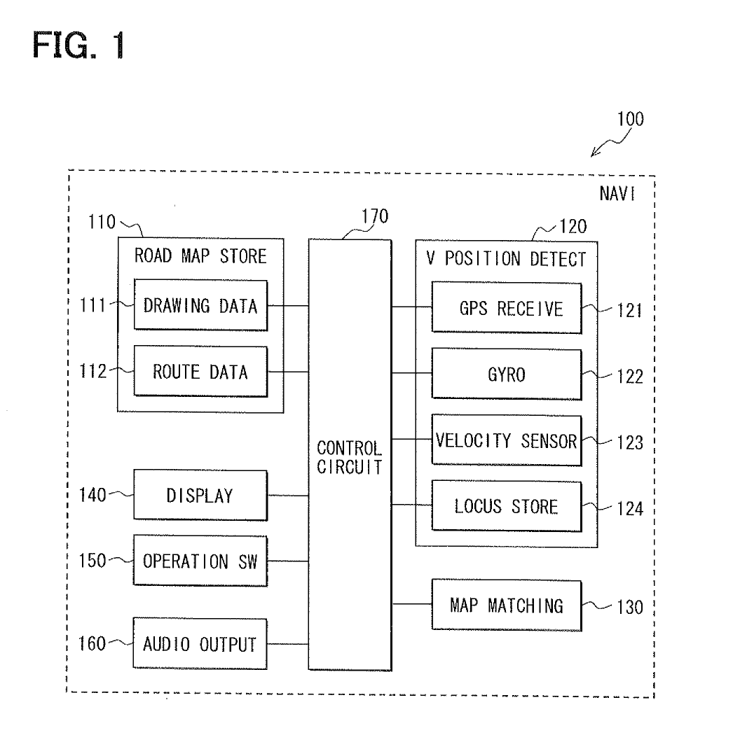

FIG. 1 illustrates a block diagram showing a configuration of a vehicular navigation apparatus 100 mounted in a subject vehicle. The navigation apparatus 100 is provided with a map database 110, a subject vehicle position detection device 120, a map matching process device 130, a display device 140, an operation switch 150, an audio output device 160, and a control circuit 170.

The map database 110 is also referred to as a road map storage device and stores the following: drawing data 111 in which the map information is stored in units in order to draw a map in the display device 140; route data 112 used for route retrieval etc; and image data and audio data for guidance. The map database 110 uses as a storage medium a ROM (Read Only Memory), a hard disk, a memory, etc.

The drawing data 111 includes polygon data of facilities such as a road, a railway, a building, and a private land; background data for drawing a geographical feature of a sea, a river, etc.; and facility data which stores position information relative to the various facilities which exist on the map.

The route data 112 includes road map information as network information containing nodes indicating connecting points, and links connecting between nodes. The links and nodes respectively corresponding to roads and intersections are provided with information such as identification numbers given to each link and node; road classes such as a highway, a toll road, a main road, and a narrow street; traffic regulations of right/left turn prohibition, one-way traffic, speed limit, etc.; widths; the numbers of lanes; slopes; and shapes of roads. Further, each link or each node is assigned with a cost based on the above mentioned information. Based on the route data 112, the control circuit 170 executes an optimal route calculation using the well-known Dijkstra method etc.

The vehicle position detection device 120 is provided with a GPS receiver 121, a gyro sensor 122, a vehicle velocity sensor 123, and a travel locus storage device 124. The GPS receiver 121 detects vehicle position information (longitude and latitude information) and present time information by receiving transmission radios from satellites of GPS (Global Positioning System) via a GPS antenna. The gyro sensor 122 detects a magnitude of a rotational movement applied to the subject vehicle, and calculates a moving direction of the subject vehicle. The velocity sensor 123 detects a velocity of the subject vehicle. It is noted that each sensor or the like 121 to 123 has a specific error.

The vehicle position detection device 120 calculates a subject vehicle position and a travel locus (also referred to a vehicle swept path, or vehicle trajectory) of the subject vehicle using the dead reckoning navigation based on signals outputted from the sensors or the like 121 to 123. In detail, a relative subject vehicle position is detected every predetermined road section (for example, 2 meters) based on a movement distance (i.e., a travel distance) of the subject vehicle calculated based on the subject vehicle position information detected by the GPS receiver 121, a vehicle velocity detected by the velocity sensor 123, and a movement direction of the vehicle detected by the gyro sensor 122. A travel locus of the subject vehicle is calculated by connecting the subject vehicle positions detected each time the subject vehicle moves 2 meters. When calculating the travel locus using the dead reckoning navigation, each sensor is mutually complemented so as to detect a subject vehicle position. However, an error by the voltage offset possessed by the gyro sensor is not complemented; thereby, the travel locus of the subject vehicle calculated by the dead reckoning navigation accumulates an error with the increase of the travel distance. The disparity between the actual travel locus and the travel locus calculated by the dead reckoning navigation becomes great. Furthermore, the vehicle position detection device 120 may further include a geomagnetic sensor for detecting a heading direction from geomagnetism, in addition to the above mentioned sensors.

The travel locus storage device 124 stores a travel locus of the subject vehicle calculated by above-mentioned dead reckoning navigation. In addition, the travel locus storage device 124 stores as a new road feasibility travel locus a travel locus of the subject vehicle at the time of an event occurring which the map matching process device 130 determines that the map matching is impossible.

The map matching process device 130 executes a collation by comparing the travel locus of the subject vehicle, which is calculated by the dead reckoning navigation and stored in the travel route storage device 124, with the shapes of the links to which the roads on the map stored in the map database 110 correspond thereby executing a map matching process to position the subject vehicle position on the road of the map. In detail, the collation is made between (i) a shape of a travel locus to a present position from a position, which is located in back by a predetermined road section (for example, 30 meters) from the present position, and (ii) a shape of a link to which each road existing on the map of the vicinity of the subject vehicle position (longitude and latitude information) detected by the GPS receiver 121 corresponds. The road including a link which provides the highest correlation is estimated as a road in which the vehicle travels. There is a case where the collation results in any road not providing a correlation exceeding a predetermined threshold value. In such a case, it is determined that the vehicle is not traveling any road which is stored in the map database 110; thereby, the execution of the map matching, becomes impossible (i.e., a map matching impossible status). It is noted that the position information (longitude and latitude information) on each position on the road with which the subject vehicle is map matched is stored as map matching history information.

The display device 140 includes a liquid crystal display in which a colored presentation is possible. The display device 140 displays a map containing the background data and polygon data in the drawing data 111, a mark indicating a present position of the vehicle, and a guidance route to a destination, in superimposition in a display screen. Further, a symbol, name, landmark of each facility and traffic congestion information may be displayed in superimposition with the map. The display device 140 can use a plasma display or an organic electroluminescence display other than the liquid crystal display.

The operation switch 150 includes mechanical button switches arranged in the circumference of the display screen of the display device 140 and a touch sensitive panel integrated into a surface of the display screen on the display device 140. Furthermore, the touch panel and the display device 140 are laminated integrally. In addition, although the touch panel includes various types to detect a user's manipulation such as a pressure-sensitive type, an electromagnetic induction type, a capacitive sensing type, or a type combining the foregoing, any type may be used in the present embodiment.

The audio output device 160 includes a speaker, and outputs various guidance sounds based on audio data for guidance stored in the map database 110.

The control circuit 170 includes a known microcomputer having a CPU, ROM, RAM, I/O, and a bus line connecting the foregoing components or the like. Based on programs stored in the ROM etc., a map display process and a route guidance process are executed. In the map display process, a map is displayed in the display device 140 such that the map covers an area range designated by an operation via the operation switch 150; in the route guidance process, an optimal route from a present position to a destination is calculated automatically and a route guidance for the optimal route is executed.

(Functions)

The map matching process device 130 may function as a new road travel determination means or section. In addition, the control circuit 170 may function as a new road update means or section, an error accumulation calculation means or section, and an error accumulation amendment means or section.

The following explains a road learning process which is executed by the control circuit 170 so as to update the map database 110 by adding as a new road a travel locus (new road feasibility travel locus) of which map matching is impossible.

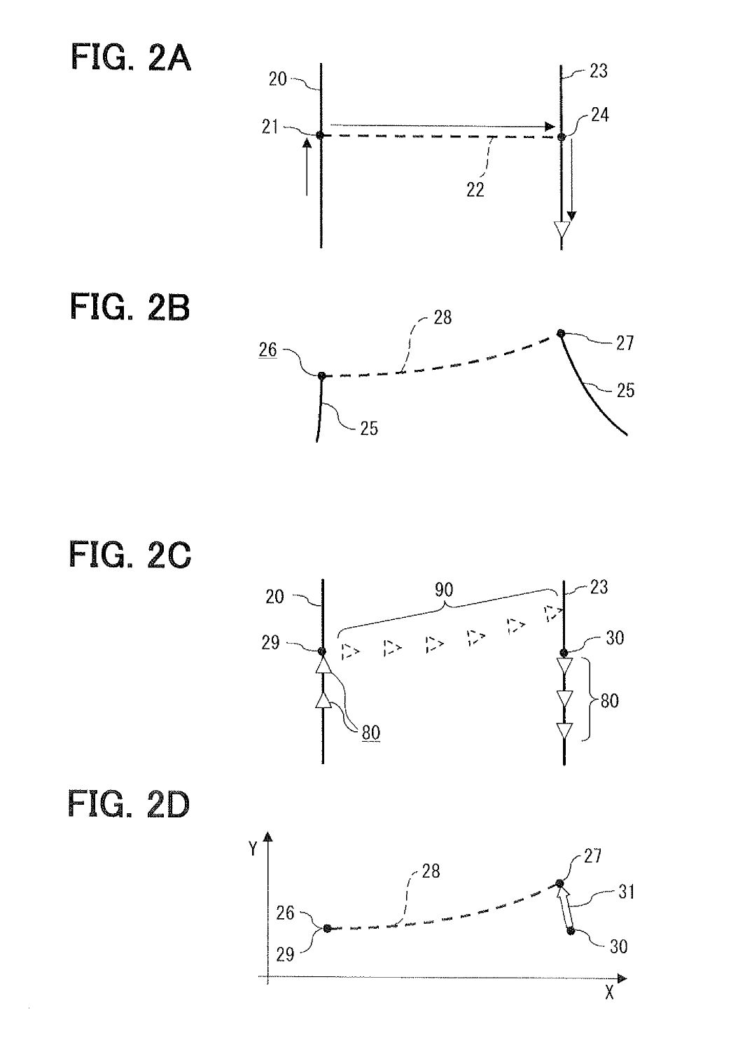

The first explains an error, which is produced or accumulated in a new road feasibility travel locus using FIGS. 2A to 2D. FIG. 2A illustrates an example where a vehicle separates or deviates from a first existing road 20 at a first new intersection 21, and then travels a new road 22, and enters or returns to a second existing road 23 at a second new intersection 24 intersected by both the new road 22 and second existing road 23.

FIG. 2B illustrates a travel locus stored in the travel locus storage device 124 when the vehicle travels the route, which is indicated by arrows in FIG. 2A. The travel locus of the subject vehicle is a locus which is produced by connecting the subject vehicle positions detected every 2 meters using the dead reckoning navigation. As understood from comparing the actual route (FIG. 2A) of the subject vehicle with the travel locus (FIG. 2B) from the dead reckoning navigation, an error arises in the shape of the travel locus of the subject vehicle based on the dead reckoning navigation. This is because a fixed error arises with respect to the heading direction of the subject vehicle because of the voltage offset of the gyro sensor 122. In addition, in FIG. 2B, a solid line in the travel locus of the subject vehicle indicates a travel locus 25 for which the map matching is possible; a broken line indicates a travel locus 28 (new road feasibility travel locus 28) for which the map matching is impossible. The starting point 26 of the travel locus for which the map matching is impossible is a first point on the travel locus of the subject vehicle at the time when the map matching for the first point becomes impossible. In contrast, the terminating point 27 is a second point detected on the travel locus of the subject vehicle at the time when the map matching for the second point is becomes possible again. A portion of the travel locus of the subject vehicle ranging between the starting point 26 and the terminating point 27 is stored as a new road feasibility travel locus 28 in the travel locus storage device 124.

Then, FIG. 2C illustrates an image displayed in the display screen of the display device 140 when the subject vehicle runs a route indicated by the arrows in FIG. 2A. The map matching is possible for a first duration for which the vehicle is running the first existing road 20; thus, the subject vehicle position 80 is positioned on the road of the map. However, the vehicle or vehicle position then deviates from the first existing road 20 at a separating point 29 corresponding to the first new intersection 21 and travels the new road 22. For such a second duration, the map matching is impossible since it is determined that the vehicle does not travel any road stored in the map database 110. Therefore, for the second duration, the subject vehicle position is displayed on the map by using the subject vehicle position 90 detected by using the dead reckoning navigation. In addition, the subject vehicle returns to the second existing road 23 at a returning point 30 corresponding to the second new intersection 24 and then travels the second existing road 23. For such a third duration, the map matching is possible, the subject vehicle position 80 is positioned on the road of the map. It is noted that the separating point 29 is positioned on the link corresponding to the first existing road 20. When updating the map database 110 by adding the new road 22, the separating point 29 is updated as a node corresponding to the first new intersection 21. Similarly, the returning point 30 is updated as a node corresponding to the second new intersection 24.

FIG. 2D illustrates a diagram which plots the separating point 29, the returning point 30, and the new road feasibility travel locus 28 on coordinates (X, Y) of an identical plane. It is noted that the plotting is made such that the starting point 26 of the new road feasibility travel locus 28 accords with the separating point 29 on the coordinates. Further, the new road feasibility travel locus 28 is plotted on the plane coordinates such that an angle between (i) the heading direction of the subject vehicle in the travel locus calculated by the dead reckoning navigation just before the time when the map matching becomes impossible at the separating point 29, and (ii) the actual heading direction of the subject vehicle is zero. The actual heading direction of the subject vehicle is obtained based on the direction of the link corresponding to the first existing road 20 the vehicle ran. The gap between the terminating point 27 and the returning point 30 on the plane coordinates turns into an accumulated error 31 (or referred to as an error accumulation).

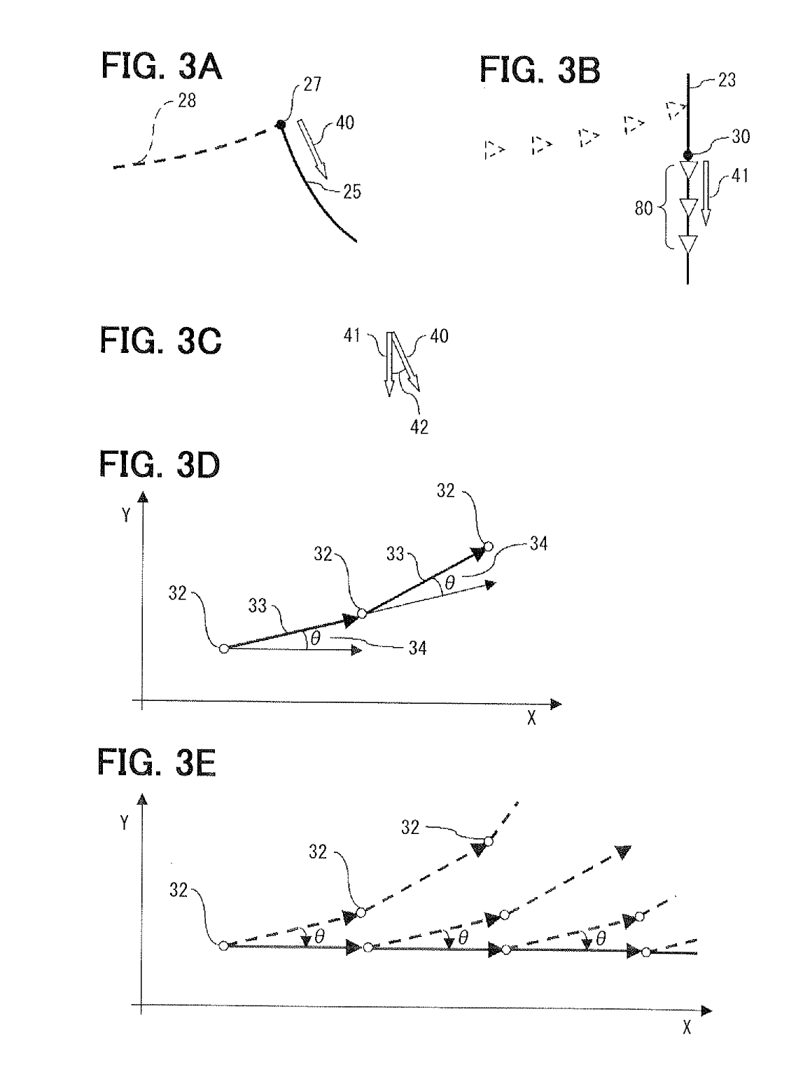

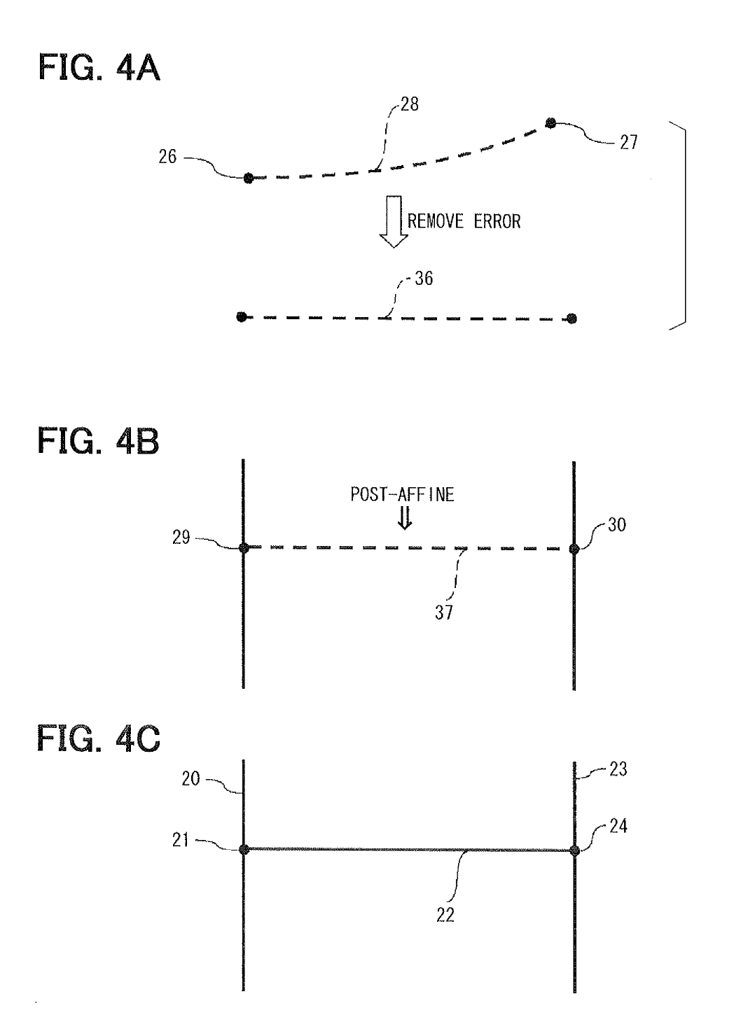

The following explains an error amendment process to amend an error arising in the new road feasibility travel locus 28 in the present embodiment with reference to FIGS. 3A to 3E, and FIGS. 4A to 4C. First, a calculation is made to obtain an accumulated direction error, which is produced in the heading direction of the subject vehicle because of the voltage offset of the gyro sensor 122 and accumulated while the subject vehicle runs the new road feasibility travel locus 28. In detail, the accumulated direction error can be calculated from an angle difference between (i) the heading direction 40 (see FIG. 3A) of the subject vehicle in the travel locus calculated by the dead reckoning navigation just after the time when the map matching becomes possible again at the returning point 30, and (ii) the actual heading direction 41 (see FIG. 3B) of the subject vehicle. FIG. 3C illustrates an angle difference 42, which is an accumulated direction error for a duration for which the subject vehicle travels the new road 22 or the new road feasibility travel locus 28.

Next, FIG. 3D illustrates the subject vehicle positions 32 detected every predetermined road section (for example, 2 meters) using the dead reckoning navigation. Connecting those positions 32 results in obtaining the new road feasibility travel locus 28. Each unit travel locus 33 which connects two positions 32 contains a fixed unit angle error θ 34 due to the voltage offset of the gyro sensor 122. Therefore, the accumulated direction error (angle difference 42) where the unit angle errors 34 are accumulated becomes large proportionally with the increase of the length or travel distance of the new road feasibility travel locus 28 (i.e., with the increase of the number of detection points of the subject vehicle positions 32). The error arises in the heading direction of the subject vehicle because of the unit angle error 34; thereby, the error accumulated by the travel locus of the subject vehicle turns into the accumulated error 31 in FIG. 2D.

Suppose a case that the new road feasibility travel locus 28 is a aggregation of N pieces of the subject vehicle positions 32 (i.e., the number of the unit locus points is N). In such a case, the fixed unit angle error θ 34 arises at each (i.e., unit locus 33) of the loci which connects two detection points or two subject vehicle positions 32; thus, the accumulated angle error (angle difference 42) is divided by N, thereby calculating an angle θ of the unit angle error 34. After calculating the unit angle error θ 34, as indicated in FIG. 3E, the error of each unit locus 33 which connects two adjacent points in a range between the first position 32 and the N−1st position 32 is removing recursively; thus, the accumulated error is amended.

The error included in the new road feasibility travel locus 28 is removed by the above mentioned amendment; as illustrated in FIG. 4A, a post-angle-amendment travel locus 36 can be obtained so as to resemble the actual road shape of the new road 22. The post-angle-amendment travel locus 36 then undergoes an affine transformation in which rotation and/or scale change such as expansion and reduction are applied to the post-amendment travel locus 36 to allow the starting point and terminating point to accord with the separating point 29 and returning point 30 on the map, respectively, thereby obtain an update use travel locus 37 (i.e., a post-affine travel locus 37), as indicated in FIG. 4B.

As illustrated in FIG. 4C, the update use travel locus 37 (also referred to as a post-amendment travel locus) is added in the map database 110 so as to be a new link corresponding to the new road 22 linked to the two nodes corresponding to the first new intersection 21 and the second new intersection 24. In addition, the new link is stored in association with information for expressing the shape of the new road 22 on the map. In detail, the update use travel locus 37 is divided every predetermined resolution (e.g., 30 meters) to detect each shape feature point every predetermined distance; then, the information of those shape feature points is stored as link information. When the shape of the update use travel locus 37 is curved or long enough, the update use travel locus 37 can be expressed by using several links corresponding to the new road along with each node connecting two links of the several links.

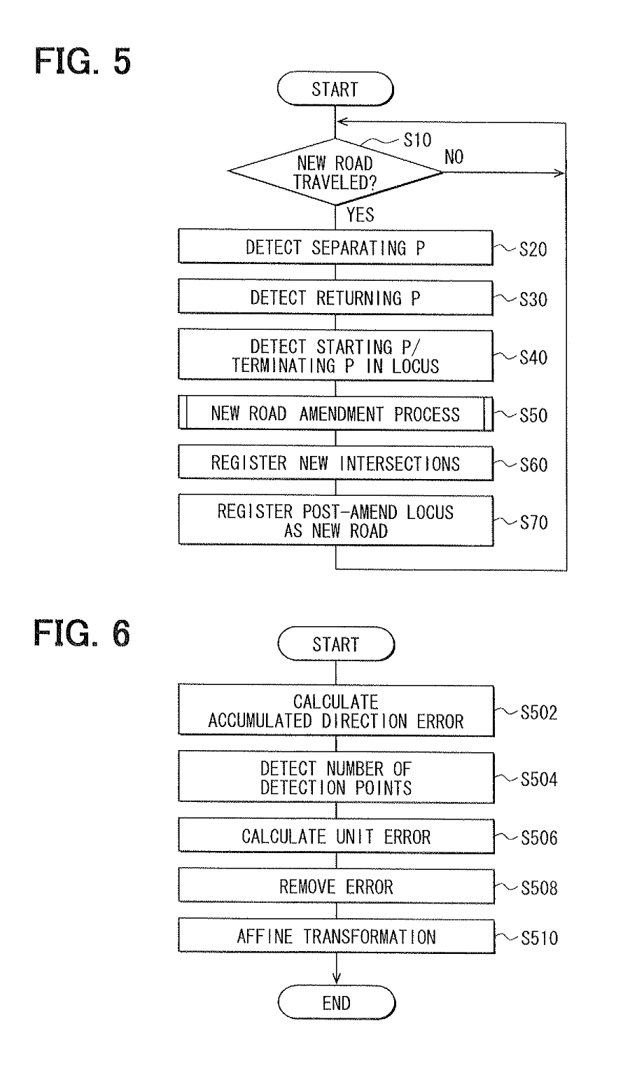

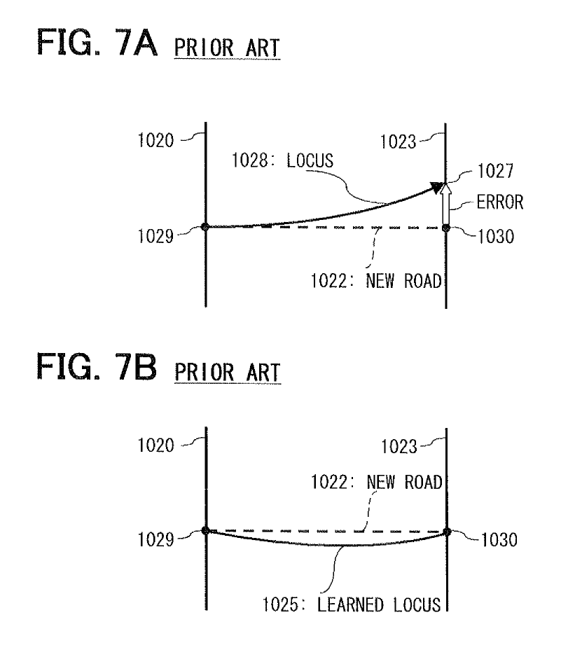

The following explains the above mentioned road learning process with reference to flowcharts of FIGS. 5 and 6. Processing indicated in those flowcharts is executed according to a computer program stored in the control circuit 170. In other words, the flowcharts are executed by the control circuit 170 based on the stored program.

It is further noted that a flowchart or the processing of the flowchart in the present application includes sections (also referred to as steps), which are represented, for instance, as S10. Further, each section can be divided into several subsections while several sections can be combined into a single section. Furthermore, each of thus configured sections can be referred to as a means or unit and achieved not only as a software device but also as a hardware device.

First, the present process is started when the ignition key of the subject vehicle is turned into an ON state. At 510, it is determined whether the subject vehicle travels a new road which is not stored in the map database 110. In detail, the determination that the vehicle traveled a new road is made when the vehicle traveled a route having a starting point at which the status of the map matching moved from a possible state into an impossible state and a terminating point at which the status of the map matching moved from the impossible state into the possible state again. Such a determination may be made based on an average velocity, a travel distance of the vehicle, or an image by a camera capturing an area surrounding the subject vehicle traveling the route for which the map matching is impossible. For instance, when the vehicle velocity is slow or small, there is a high possibility that the vehicle travels within a facility instead of a new road; thus, it is not determined that the vehicle traveled a new road. When it is determined that the vehicle traveled a new road (510: YES), the processing advances to S20. The determination at S10 is repeatedly executed until the determination is affirmatively made; namely, it is determined that the vehicle traveled a new road.

At S20, position information of a separating point 29 is detected from subject vehicle positions stored in the map matching process device 130. As explained above, at the separating point 29 the status of the map matching moved from the possible state into the impossible state. At S30, position information of a returning point 30 is detected from subject vehicle positions stored in the map matching process device 130. Similarly, as explained above, at the returning point 30 the status of the map matching moved from the impossible state into the possible state again.

At S40, in the travel locus based on the dead reckoning navigation stored in the travel locus storage device 124, a starting point and a terminating point of the travel locus for which the map matching is impossible are detected and a travel locus between the starting point and the terminating point is defined as a new road feasibility travel locus 28.

At S50, an amendment process subroutine of the new road feasibility travel locus 28 is executed. Explanation of the amendment process subroutine of the new road feasibility travel locus 28 is mentioned later.

At S60, the separating point 29 and returning point 30 are registered in the map database 110 as new intersections based on each position information. The new intersections are registered in the map database 110 as two nodes 21, 24 at each of which the link corresponding to the new road 22 is connected with the link corresponding to the existing road 20, 23.

At S70, the update use travel locus posterior to the amendment process at S50 (also referred to a post-amendment travel locus) is registered as a new road 22 in the map database 110. The new road is registered in the map database 110 as a link which connects the two nodes corresponding to the new intersections in association with the shape of the link.

Next, the amendment process subroutine of the new road feasibility travel locus 28 at S50 is explained with reference to FIG. 6. As the start of the amendment process subroutine, at S502, an accumulated direction error is calculated which is produced while the vehicle travels the new road 22 of the new road feasibility travel locus 28. The calculation method for calculating the accumulated direction error is the same as that explained in the above.

At S504, the number (N) of locus points (unit locus) included in the new road feasibility travel locus 28 is detected. At S506, a unit angle error 34 is calculated by dividing the accumulated direction error calculated at S502 by N detected at S504. At S508, based on the unit angle error 34 calculated at 8506, an error included in the new road feasibility travel locus 28 is removed. The calculation method for removing the error is the same as that explained in the above.

At S510, an affine transformation is executed so as to accord the starting point and terminating point of the locus, an error of which was removed at S508, with the separating point 29 and the returning point 30. In the affine transformation, the shape of the travel locus posterior to the direction error removal is subjected to a rotation process and scale change process of expansion or reduction, thereby obtaining the update use travel locus 37 (also referred to as a post-amendment travel locus or a post-affine-amendment travel locus).

According to the present embodiment, when updating or adding a new road, the shape of the new road is based on the continuous travel locus by the dead reckoning navigation to thereby become smooth like a road. This helps prevent a use from feeling a sense of incongruity. In addition, the present embodiment removes the error, which is produced from the offset voltage of the gyro sensor 122 and contained in the new road feasibility travel locus 28 by the dead reckoning navigation when the subject vehicle travels the new road. The new road can be thus added in the update process of the map data so as to fit more with the actual shape of the new road.

Furthermore, the present embodiment explains the case where the error included in the new road feasibility travel locus 28 is only a direction error produced because of the offset voltage of the gyro sensor 122. However, even when the new road feasibility travel locus 28 contains not only the direction error but a fixed distance error (i.e., a fixed error in travel distance) as well, those errors can be removed by a process comparative with that of the present embodiment. For example, the error in the travel distance produced because of the offset voltage of the GPS receiver 121 can be removed as follows. First, the direction error is removed from the new road feasibility travel locus 28 at S508 in FIG. 5. Second, the new road feasibility travel locus 28 posterior to the direction error removal (i.e., the post-angle-amendment travel locus 36) is subjected to the Affine transformation such that the starting point and terminating point accord with the separating point 29 and the returning point 30, respectively. The error in the travel distance can be removed in the affine transformation executing a rotation process and scale change process of expansion or reduction.

Aspects of the disclosure described herein are set out in the following clauses.

As an aspect of the disclosure, a road learning apparatus for a vehicle is provided as follows. A road map storage device is configured to store road map data. A vehicle position detection device is configured to detect a position of the vehicle using a dead reckoning navigation. A travel locus storage device is configured to store a travel locus generated by a movement of a vehicle position detected by the vehicle position detection device. A new road travel determination section is configured to execute a new road travel determination as to whether the vehicle travels a new road that is not contained in the stored road map data. A new road update section is configured to update the road map data in the road map storage device by adding a new road based on a travel locus stored in the travel locus storage device when the new road travel determination is affirmatively made. An error accumulation calculation section is configured to calculate, when the new road travel determination is affirmatively made, an error which is accumulated in a first travel locus corresponding to the new road for a duration for which the vehicle travels the new road. An error accumulation amendment section is configured to amend the accumulated error calculated by the error accumulation calculation section with respect to the first travel locus to obtain a second travel locus as a post-amendment travel locus. Herein, the new road update section is further configured to update the road map data in the road map storage device by adding as the new road the post-amendment travel locus obtained by the error accumulation amendment section.

As an optional aspect of the road learning apparatus, the new road update section may define a starting point of the first travel locus at a time it is determined that the vehicle starts traveling the new road by the new road travel determination section, and define a terminating point of the first travel locus at a time when it is determined that the vehicle terminates traveling the new road by the new road travel determination section. The new road update section may update the road map data by adding the new road based on the first travel locus, which is within a range between the starting point and the terminating point.

This can specify a locus portion, which is produced when the vehicle travels the new road, within the travel locus.

As an optional aspect of the road learning apparatus, the vehicle position detection device may include a vehicle direction detection device to detect a heading direction of the vehicle. The vehicle position detection device may detect a vehicle position using the dead reckoning navigation based on information outputted from the vehicle direction detection device. The error accumulation calculation section may calculate an accumulated direction error which is accumulated in the first travel locus for the duration for which the vehicle travels the new road, the accumulated direction error being produced because of an offset voltage contained in information outputted from the vehicle direction detection device.

This allows the calculation of an error accumulated in the travel locus corresponding to the new road because of the offset voltage of the device, which detects a vehicle direction, such as a gyro sensor. Then, the travel locus is amended based on the calculated error. Therefore, also even in the case where the error due to the offset voltage arises in the apparatus such as the gyro sensor, the addition of the new road in the road map data can be allowed to meet the actual shape of the new road.

Herein, as a further optional aspect, the error accumulation amendment section may make an estimation that the accumulated direction error calculated by the error accumulation calculation section is proportional to a distance of the first travel locus corresponding to the new road, and amend, based on the made estimation, the accumulated direction error with respect to the first travel locus corresponding to the new road.

Thus, the direction error accumulated in the travel locus corresponding to the new road can be amended. The addition of the new road in the road map data can be thus allowed to meet the actual shape of the new road.

Herein, as a yet further optional aspect, the vehicle position detection device may detect a vehicle position using the dead reckoning navigation each time the vehicle travels a predetermined distance. The error accumulation amendment section may calculate a unit direction error based on (i) the accumulated direction error calculated by the error accumulation calculation section and (ii) a number of times of position detections which are executed by the vehicle position detection device for the duration for which the vehicle travels the first travel locus corresponding to the new road, and amend the accumulated direction error based on the calculated unit direction error.

Thus, the direction error accumulated in the travel locus corresponding to the new road can be amended. The addition of the new road in the road map data can be thus allowed to meet the actual shape of the new road.

As an optional aspect, the vehicle position detection device may include a travel distance detection device to detect a travel distance of the vehicle. The vehicle position detection device may detect a vehicle position using the dead reckoning navigation based on information outputted from the travel distance detection device. The error accumulation calculation section may calculate an accumulated distance error which is accumulated in the post-amendment travel locus, which corresponds to the new road and is obtained by amending the accumulated direction error with respect to the first travel locus, wherein the accumulated distance error is produced because of an offset voltage contained in information outputted from the travel distance detection device. The error accumulation amendment section may further amend the accumulated distance error by applying a rotation and a scaling change including an expansion and a reduction to the post-amendment travel locus, which is obtained by amending the accumulated direction error included in the first travel locus corresponding to the new road.

Thereby, the error accumulated in the travel locus can be calculated and then amended not only when the error due to the offset voltage arises in the device to the direction of the vehicle, but also when the error due to the offset voltage arises in the device to detect the travel distance of the vehicle. The addition of the new road in the road map data can be thus allowed to meet the actual shape of the new road.

It will be obvious to those skilled in the art that various changes may be made in the above-described embodiments of the present invention. However, the scope of the present invention should be determined by the following claims.

What is claimed:

1. A road learning apparatus for a vehicle, the apparatus comprising:
a road map storage device configured to store road map data;
a vehicle position detection device configured to detect a position of the vehicle using a dead reckoning navigation;
a travel locus storage device configured to store a travel locus generated by a movement of a vehicle position detected by the vehicle position detection device;
a new road travel determination section configured to execute a new road travel determination as to whether the vehicle travels a new road that is not contained in the stored road map data;
a new road update section configured to update the road map data in the road map storage device by adding a new road based on a travel locus stored in the travel locus storage device when the new road travel determination is affirmatively made;
an error accumulation calculation section configured to calculate, when the new road travel determination is affirmatively made, an error which is accumulated in a first travel locus corresponding to the new road for a duration for which the vehicle travels the new road; and
an error accumulation amendment section configured to amend the accumulated error calculated by the error accumulation calculation section with respect to the first travel locus to obtain a second travel locus as a post-amendment travel locus,
the new road update section being further configured to update the road map data in the road map storage device by adding as the new road the post-amendment travel locus obtained by the error accumulation amendment section.

2. The road learning apparatus according to claim 1, wherein:
the new road update section
defines a starting point of the first travel locus at a time it is determined that the vehicle starts traveling the new road by the new road travel determination section, and
defines a terminating point of the first travel locus at a time when it is determined that the vehicle terminates traveling the new road by the new road travel determination section; and
the new road update section updates the road map data by adding the new road based on the first travel locus, which is within a range between the starting point and the terminating point.

3. The road learning apparatus according to claim 1, wherein:
the vehicle position detection device includes a vehicle direction detection device to detect a heading direction of the vehicle;
the vehicle position detection device detects a vehicle position using the dead reckoning navigation based on information outputted from the vehicle direction detection device; and
the error accumulation calculation section calculates an accumulated direction error which is accumulated in the first travel locus for the duration for which the vehicle travels the new road, the accumulated direction error being produced because of an offset voltage contained in information outputted from the vehicle direction detection device.

4. The road learning apparatus according to claim 3, wherein:
the error accumulation amendment section
makes an estimation that the accumulated direction error calculated by the error accumulation calculation section is proportional to a distance of the first travel locus corresponding to the new road, and
amends, based on the made estimation, the accumulated direction error with respect to the first travel locus corresponding to the new road.

5. The road learning apparatus according to claim 4, wherein:
the vehicle position detection device detects a vehicle position using the dead reckoning navigation each time the vehicle travels a predetermined distance; and
the error accumulation amendment section
calculates a unit direction error based on (i) the accumulated direction error calculated by the error accumulation calculation section and (ii) a number of times of position detections which are executed by the vehicle position detection device for the duration for which the vehicle travels the first travel locus corresponding to the new road, and
amends the accumulated direction error based on the calculated unit direction error.

6. The road learning apparatus according to claim 3, wherein:
the vehicle position detection device includes a travel distance detection device to detect a travel distance of the vehicle;
the vehicle position detection device detects a vehicle position using the dead reckoning navigation based on information outputted from the travel distance detection device;
the error accumulation calculation section calculates an accumulated distance error which is accumulated in the post-amendment travel locus, which corresponds to the new road and is obtained by amending the accumulated direction error with respect to the first travel locus, the accumulated distance error being produced because of an offset voltage contained in information outputted from the travel distance detection device; and
the error accumulation amendment section further amends the accumulated distance error by applying a rotation and a scaling change including an expansion and a reduction to the post-amendment travel locus, which is obtained by amending the accumulated direction error included in the first travel locus corresponding to the new road.

7. A method for updating road map data to add a new road for a vehicle having a storage device storing the road map data, and a vehicle position detection device detecting a position of the vehicle using a dead reckoning navigation,
the method comprising:
recording a travel locus generated by a movement of a vehicle position detected by the vehicle position detection device;
executing a new road travel determination as to whether the vehicle travels a new road that is not contained in the stored road map data;
defining, when the new road travel determination is affirmatively made, within the recorded travel locus, a first travel locus corresponding to the new road for a duration for which the vehicle travels the new road;
calculating an error which is accumulated in the first travel locus corresponding to the new road for the duration for which the vehicle travels the new road;
amending the calculated error accumulated in the first travel locus to obtain a second travel locus as a post-amendment travel locus; and
updating the road map data in the storage device by adding as the new road the obtained post-amendment travel locus.
